(19) United States
(12) Patent Application Publication
(10) Pub. No.: US 2026/0217483 A1
(43) Pub. Date: Jul. 30, 2026

(54) DE-PALLETISER AND PALLETISER

(71) Applicant: Ocado Innovation Limited, Hatfield (GB)

(72) Inventors: Oliver KIRKBY, Hatfield (GB); Leslie WYNN, Hatfield (GB)

(21) Appl. No.: 19/574,596

(22) Filed: Mar. 23, 2026

Related U.S. Application Data
(63) Continuation of application No. PCT/EP2024/077156, filed on Sep. 26, 2024.

(30) Foreign Application Priority Data
Sep. 29, 2023 (GB) 2314987.5

(51) Int. Cl. B65G 60/00; B25J 9/02; B25J 9/04; B25J 15/00

(52) U.S. Cl. CPC B65G 60/00; B25J 9/026; B25J 15/0014; B25J 15/0052; B25J 9/043

(57) ABSTRACT

A pallet unloading and loading apparatus includes: a pivot member for supporting a container, and a guide rail arranged above the pivot member, the guide rail supporting an engagement feature for engaging with a sidewall of a target container, the engagement feature being moveable in a substantially horizontal direction along the guide rail relative to the pivot member. The engagement feature allows relative vertical movement between the engagement feature and the pivot member whereby movement of the engagement feature in the vertical direction relative to the pivot member causes the target container to tilt on a container in a layer immediately below the target container or on the pallet. Relative movement between the engagement feature and the pivot member in the substantially horizontal direction causes the target container to pivot about the pivot member as it is moved onto or removed from the pivot member.

### RELATED APPLICATIONS

This application is a continuation of International Patent Application No. PCT/EP2024/077156, filed 26 Sep. 2024 and entitled “De-palletiser and Palletiser,” which claims priority to UK Patent Application No. GB2314987.5, filed 29 Sep. 2023 and entitled “De-palletiser and Palletiser”; the entire contents of all of which applications are incorporated herein by reference.

### TECHNICAL FIELD

The present invention relates to the field of a material handling system, more specifically to an apparatus for unloading or loading a pallet.

### BACKGROUND

Most products are delivered to warehouses on pallets, where the products must be unloaded from the pallets so that the products can be processed at the warehouse by a material handling system. The products can be stored in boxes, containers or crates and stacked in multiple layers on the pallet. Whether the products are stored in boxes, containers or crates, for the purpose of definition in the present invention, such products can be termed ‘units’. Once unloaded, the pallets are collected and then returned for reuse. Pallets come in various types and generally comprise a top deck usually formed from a series of planks, otherwise known in the art as runners and a lower deck spaced from the top deck by blocks of wood.

Once at the warehouse, the products need to be removed from pallets (known as de-pelletising) and singulated so they can be stored in an automatic storage and retrieval system. PCT Publication No. WO2015019055A (Ocado Innovation Limited) describes a known storage and fulfilment system in which stacks of storage bins or containers are arranged within a grid framework structure. The bins or containers are accessed by load handling devices remotely operative on tracks located on the top of the grid framework structure. In this system, the products and/or other multi-packs of inbound items removed from the pallet are separated and placed, individually or in groups corresponding to their stock keeping unit (SKU) into separate storage containers for storage in the storage and retrieval system. The bins or containers are accessed by load handling devices remotely operative on tracks located on the top of the grid framework structure.

Some products such as fruit, vegetables and meat are stored in crates, typically plastic crates, to prevent damage to the products in transit on pallets in multiple layers to a warehouse. IFCO (International Food Container Organization) trays (also known as RPCs (reusable packaging containers), or reusable containers, or reusable crates) are a type of reusable packaging for transporting fresh food produce. Often, such crates are open-topped. The storage containers are generally sized such that crates will fit inside the storage containers which are then placed in storage in the grid framework structure removing the need to unpack the crates.

As the products are stored in multiple layers on a pallet, the products tend to be de-palletized in layers with the uppermost layer of products being the starting point layer and successive layers being removed from the pallet. There are usually two approaches to do this. The first is manual de-palletisation, where operators pick the products individually and forward them on an outfeed conveyor. The other approach is to use an automated de-palletiser comprising a robot arm equipped with a layer de-palletizing tool to remove the products layer by layer and drop them on an outfeed conveyor. Similarly, products destined to leave a warehouse may leave on pallets, which requires similar or different products to be placed on the pallet. This process is known as palletisation, where the items are placed, typically on a one-by-one or layer-by-layer basis, on the pallet. That is, each product is placed to form a current top layer of products on the pallet before proceeding to placing products on the next layer (which then becomes the current top layer).

There are various types of automated de-palletisers known in the art. For example, it is known to de-palletize by successively removing layers or parts of layers from the top of a stack of packages with the aid of a suction device. Apart from the relatively high cost of the apparatus required, there is the disadvantage that during removal of a number of packages at the same time too much air can easily reach the suction head from underneath, as a result of which the lifting capacity greatly diminishes. Furthermore, if the packages are not completely closed the contents can easily be damaged, for example, with packages containing powders.

Another de-palletizing method involves gripping the sides of a layer of packages and then lifting it from the stack. As high lateral pressures are generally required for a layer consisting of a number of packages, this leads in practice to a limited lifting capacity, while at the same time the packages can easily be damaged.

It has also been proposed to de-palletise packages by using an apparatus in a fixed location to which the stacked packages have to be brought. The apparatus comprises an extendable part of a conveyor roller system, with the leading roller contacting the stacked packages in turn and by frictional contact raising the packages to a position where they ride over the leading roller and pass to fixed conveyor rollers for removal elsewhere. This arrangement has the disadvantage that the apparatus cannot readily be used for de-palletising stacks of different sizes of packages. For example, GB1559973 (Unilever Ltd) teaches a de-palletiser comprising a roller that is placed in contact with a box under sufficient pressure, the friction between the roller and the box causes the box to be lifted. Rotation of the roller causes the box to slip under the box and the box pass over the roller until it lands on a conveyor belt, where it is removed for distribution. Similarly, WO2009043151 (Axium Inc) teaches a de-palletizing tool for de-palletizing a layer of products on a pallet. The tool is mounted to a robot via a frame, the robot allowing for movements of the tool relative to the pallet. The tool includes a platform mounted to the frame and is provided with a motorized conveyor at the distal end thereof for inserting at least partially the platform under the layer of products and for raising the products onto the platform while the tool is moved towards the distal end of the layer by the robot. The tool includes a pusher also mounted to the frame over the platform for selectively applying pressure onto the products while the platform is inserted under the layer of products.

However, in both teachings it is essential that the target product or package need to be supported to prevent excessive lateral movement on the pallet in order to provide the necessary reaction force for the pushing force of the roller to slip under the product or package. This is usually provided by the target product or package butting up against another product or package adjacent to the target product or package in a layer on the pallet. Without this reaction force from an adjacent product or package in the layer on the pallet, the roller is unable to lift the product or package and slip under the product or package. The pushing force may simply move the package on the pallet without any real lifting of the package and in a worst case scenario, the package may be pushed off the edge of the pallet. An additional problem with inserting a platform under the product is that the platform has the potential to damage or pinch the contents of the packages if the packages in the layer below the package are not completely closed. This is particularly the case, where the content of the products can be easily bruised such as soft fruit. Even if the more sensitive products such as fruit, vegetables and meat are stored in crates, e.g. IFCO crates, to prevent damage to the products during transit, the risk of damage to the products during de-palletisation can be still present. For example, sensitive items protruding from the crates are susceptible to damage by the lifting platform when attempts are made to remove the crates in the layer above.

A palletiser or de-palletiser is thus required that can unload and/or load one or more products stored in containers of a plurality of containers stacked in multiple layers on a pallet that does not suffer from the problems described.

### SUMMARY OF THE INVENTION

The present invention has mitigated, and provides for mitigation of, the above problems by providing a tool or apparatus for de-palletising a pallet, the pallet comprising a plurality of containers stored in multiple layers on the pallet. The apparatus comprises a pivot member to provide a double pivot action in order to pivot a target container about its rear end on a layer immediately below the target container and subsequently pivot the target container on the pivot member so that the target container can be lifted clear off the layer immediately below the target container onto the pivot member. The pivot member may be the edge of a planar support, or platform. Further, the pivot member may comprise a lip, bar or roller. More specifically, the present invention provides an apparatus for unloading or loading one or more containers of a plurality of containers stacked up in multiple layers on a pallet, each of the plurality of containers comprising a bottom wall and upwardly standing sidewalls.

An example of the apparatus includes: (a) a pivot member for supporting a container; and (b) a guide rail arranged above the pivot member, the guide rail supporting an engagement feature for engaging with a sidewall of a target container, the engagement feature is moveable in a substantially horizontal direction along the guide rail relative to the pivot member; wherein the engagement feature is configured such that there is relative vertical movement between the engagement feature and the pivot member, in use, when the engagement feature is engaged with the sidewall of the target container, movement of the engagement feature in the vertical direction relative to the pivot member causes the target container to tilt on a container in a layer immediately below the target container or on the pallet and relative movement between the engagement feature and the pivot member in the substantially horizontal direction causes the target container to pivot about the pivot member as it is moved onto or removed from the pivot member. The pivot member effectively acts as a fulcrum for pivoting the target container about the pivot member.

The double pivot action of the target container is made possible by the relative movement in a vertical direction between the engagement feature and the pivot member. The relative movement in the vertical direction between the engagement feature and the pivot member cause the container to be held or trapped between the engagement feature and at least the pivot member and this enables the target container to be lifted at one end so that it can be tilted or pivoted by its rear end on the layer below the target container. Once tilted, the target container is able to be pulled towards the pivot member, whereupon, further pulling causes the target container to pivot about the pivot member such that the rear end of the target container can be lifted clear off the layer below the target container. Relative movement in the substantial horizontal direction between the engagement feature and the pivot member is not limited to the engagement feature pulling on the target container towards the pivot member but also covers the scenario where the pivot member pushes in one direction and the engagement feature pulls in the opposite direction such that at any given time, the target container remains substantially stationary while it is being lifted off the container below the target container or the pallet. Relative movement between the engagement feature and the pivot member in the substantial horizontal direction mitigates an excessive pulling force being applied to the sidewall of the target container when pulling the target container onto the pivot member.

In a worst-case scenario, the pulling force may damage the sidewall of the target container if the pulling force is too excessive as the target container is moved towards the pivot member. By controlling the vertical distance between the engagement feature and the pivot member, the point at which the target container pivots about the pivot member can be varied which in turn controls the amount of force required to tilt the target container about the pivot member. Controlling the force required to pivot or rotate the target container about the pivot member can simply be explained by the effects of moments of force to cause a body to rotate about a specific point or axis.

$$τ = 𝔯 \times ℱ \qquad ( EQ . 1 )$$

Where:
   τ is the moment of force to rotate the target container about the pivot member;
   r is the distance between the point of contact with the target container and the pivot member;
   F is the force applied to the engagement feature to rotate the target container about the pivot member.

For example, a larger spacing, r, between the point of contact with the target container and the engagement feature, the lower the force, F, applied to the engagement feature to pivot the target container about the pivot member and vice-versa. In the case where the contents of the target container are relatively heavy, e.g. greater than 20 kg, the force applied to the engagement feature would be reduced if the distance between the point of contact with the target container and the pivot member is increased and this can be controlled by the vertical distance or height between the engagement feature and the pivot member. Moreover, the relative movement between the engagement feature and the pivot member can also control the point at which the pivot member contacts the underside of the target container mitigating the need to apply excessive force to pull the target container onto the pivot member.

In prior art de-palletisers involving a pivoting action, a pusher is used to tilt or pivot the target container on the layer below the target container by pushing the target container in a top layer against an adjacent container in the same layer so that the target container butts up against the adjacent container and enables the target container to ride over the pusher. The apparatus according to the present invention does away with the need to have a container adjacent the target container in the same layer in order to provide the necessary reaction force to lift the target container. In the present invention, relative movement between the engagement feature and the pivot member allows at least one end of the target container to be lifted making the process of removing the container from the pallet much easier.

To move the target container in a substantially horizontal direction once the engagement feature is engaged with the target container, optionally, the guide rail comprises an arm, said engagement feature is moveable in a longitudinal direction along the arm. Optionally, the engagement feature is moveably mounted to the guide rail to move in a vertical direction relative to the guide rail. To lift one end of the target container so that it tilts on the layer below the target container, optionally, the guide rail is guided to move in the vertical direction relative to the pivot member by a substantially vertical guide member.

In order for the engagement feature to engage with the target container prior to be lifted at one end, preferably, the guide rail extends in a longitudinal direction beyond the pivot member such that the engagement feature is moveable beyond the pivot member when engaging with the target storage container.

To engage with the target container, optionally, the engagement feature comprises a hook receivable in an opening in one or more sidewalls of the container. To prevent the engagement feature from pinching the contents of the container when it is received within the opening in the sidewall of the container, optionally, the engagement feature comprises a stop that is configured to butt up against the sidewall to limit the movement of the hook when the hook inserted into the opening of the one or more sidewalls of the container.

Optionally, the pivot member comprises the leading edge of a support platform having a longitudinal axis parallel to the movement of the engagement feature along the guide rail. The leading edge that is configured to contact the target container when the target container is pulled onto the support platform so as to cause the target container to pivot about the leading edge. To assist with the movement of the target container on the support platform, optionally, the leading edge of the support platform comprises a roller rotatable about an axis substantially perpendicular to the movement of the engagement feature along the guide rail. One of the advantages of pivoting about the support platform is that the support platform can further comprise a load cell that is configured to measure the weight of the target container on the support platform. Optionally, the load cell is disposed below the support platform. Measuring the weight of the target container as it is being de-palletised onto the support platform helps to keep track of the amount of goods being delivered to the fulfilment centre. The stock data can be used to update a stock control database. The weight measurements can also be used to correlate the actual quantity of stock inbound into the fulfilment centre with the supplier's stock order and if there are any discrepancies or missing stock, the supplier can be contacted to replenish any missing stock.

Alternatively, the pivot member comprises a roller or a bar having a longitudinal axis extending in a direction perpendicular to the movement of the engagement feature along the guide rail.

To move the target container onto the pivot member, optionally, the apparatus comprises at least one drive mechanism configured to move the engagement feature in a substantial vertical direction relative to the pivot member and in a substantial horizontal direction along the guide rail.

Optionally, the at least one drive mechanism is configured to move the engagement feature in the vertical direction relative to the guide rail. Optionally, the at least one drive mechanism comprises a linear actuator. Optionally, the at least one drive mechanism can be a single drive mechanism configured to independently drive the engagement feature in the substantial vertical direction and the substantially horizontal direction relative to the pivot member. A switch (e.g. a reed switch) can be used to independently drive the engagement feature in the substantial vertical direction and the substantially horizontal direction relative to the pivot member. Alternatively, the at least one drive mechanism comprises a lift drive mechanism configured to lift the engagement feature in the substantially vertical direction and slide drive mechanism configured to move the engagement feature in a substantial horizontal direction.

In one optional aspect of the present invention, the apparatus of the present invention can be used to lower or decant a target container into a storage container or storage bin or tote for storage in a fulfilment centre comprising a grid framework structure as taught in WO2015/019055 (Ocado Innovation Limited). To enable the apparatus to lower or decant the target container into a storage container once it has been supported on the pivot member, preferably, the pivot member is moveable in a direction parallel to the movement of the engagement feature along the guide rail. Optionally, the apparatus comprises a pivot member driving means for driving movement of the roller or bar in a direction substantially parallel to the movement of the engagement feature along the guide rail. To support the target container when it is not supported by the pivot member, optionally, the apparatus comprises a clamp comprising a pair of clamping plates downwardly extending from the guide rail, said pair of clamping plates being configured to clamp the target container. In comparison to the pivot member, the clamp enables the target container to be released in a controlled manner causing the target container to be lowered into the storage bin. Since the clamping force of the pair of clamping plates and thus, the friction between the clamping plates and the exterior of the target container gradually reduces as the clamp is released, the rate at which the target container is lowered into the storage bin can be controlled. This is particularly important where the content of the container comprises items of a fragile nature and/or to prevent damage to the contents of the container and the container itself when being lowered into the storage container.

The apparatus according the present invention is versatile in the sense that it can be retrofitted or mounted on any moving device. In another aspect of the present invention, a robotized de-palletiser for unloading or loading one or more containers of a plurality of containers stacked up in multiple layers on a pallet is provided, said robotized de-palletiser comprising a gantry comprising an apparatus according to the present invention for moving the apparatus axially in multiple X and Y orthogonal directions.

In yet a further aspect of the present invention, a robotized de-palletiser robot for unloading or loading one or more containers of a plurality of containers stacked up in multiple layers on a pallet, said robotized de-palletiser comprising a robot comprising a robot arm, wherein an end effector is coupled to the robot arm for controlling the movement of the end effector to unload or load one or more containers of a plurality of containers stacked up in multiple layers on a pallet, said end effector comprising an apparatus according to the present invention. Optionally, the robot may comprise a selective compliance assembly robot arm (SCARA) robot.

In yet a further aspect of the present invention, a vehicle for unloading or loading one or more containers of a plurality of containers stacked up in multiple layers on a pallet is provided, the vehicle comprising: (i) a body comprising a drive assembly for moving the vehicle; and (ii) an apparatus according to the present invention.

The vehicle itself can be a pallet mover, in which case, the vehicle comprises a plurality of forks for lifting and handling pallets and a lifting mechanism, the plurality of forks outwardly extending from the body and configured to be lifted by the lifting mechanism. Optionally, the vehicle is an autonomous guide vehicle comprising a location recognition sensor for detecting a location of the vehicle in a travelling direction and a control system, said control system being configured to move the vehicle in response to one or more signals from the location recognition sensor. Optionally, the location recognition sensor comprises a light detection and ranging (LiDAR) sensor comprising a laser beam source, an optical receiver and a scanning system for deflecting a laser beam generated by the laser beam source in at least two scanning directions.

The double pivoting action when de-palletising one or more containers from a pallet lends the apparatus kindly to automation. In one aspect of the present invention, the at least one drive mechanism can be controlled by a controller comprising a processor and machine executable instructions that when executed by the processor control the at least one drive mechanism to lift the target container onto the pivot member by pivoting the target container on the pallet and subsequently pivoting the target container about the pivot member as discussed above.

In an aspect of the present invention, a robotic palletizing/de-palletizing system for automatically unloading or loading one or more containers of a plurality of containers stacked up in multiple layers on a pallet is provided, each of the plurality of containers comprising a bottom wall and upwardly standing sidewalls.

An example of the above-noted robotic system may include: (a) an apparatus according to the present invention; and (b) a controller operatively coupled to the at least one drive mechanism, the control system being configured to: (i) control the movement of the engagement feature in the substantially horizontal direction along the guide rail towards the sidewall of a target container so as to engage with the sidewall of the target container; (ii) raise the engagement feature in a substantially vertical direction relative to the pivot member to cause the target container to tilt on a container in a layer immediately below the target container or on the pallet; and (iii) control relative movement between the engagement feature and the pivot member in the substantially horizontal direction to cause the target container to pivot about the pivot member when being moved onto or removed from the pivot member.

To enable the apparatus to automatically deposit or decant a target container picked up by the apparatus into a storage bin for storage in a fulfilment centre, the controller is further operatively coupled to the clamp of the apparatus to clamp opposing upwardly standing sidewalls of the target container when the target container is supported by the pivot member and the engagement feature.

The controller may further be configured to release the target container from the apparatus by controlling: (i) the movement of the engagement feature in the substantially horizontal direction along the guide rail away from the sidewall of a target container to disengage from the sidewall of the target container; (ii) the movement of the pivot member away from the target container in a direction substantially parallel to the movement of the engagement feature along the guide rail such that the target container is not support by the pivot member; and (iii) the clamping mechanism to release the target container from the pair of clamping plates.

To fully release the engagement feature from the apparatus, the control system is further configured to control the at least one drive mechanism to disengage the engagement feature from the sidewall of the target container by controlling the relative movement between the engagement feature and the pivot member in the substantially vertical direction. In the case where the engagement feature is a hook, to release the hook from an opening in the sidewall of the target container, a further movement of the hook in a downward direction is necessary to release the hook from the opening before the engagement feature is moved in the horizontal direction away from the sidewall of the target container.

### BRIEF DESCRIPTION OF DRAWINGS

Further features and aspects of the present invention will be apparent from the following detailed description of an illustrative embodiment made with reference to the drawings, in which:

FIG. 1 show an illustration of an apparatus for picking up a container from a plurality of containers stacked up in multiple layers on a pallet according to the present invention;

FIG. 2 is an illustration of the apparatus shown in FIG. 1 showing an engagement feature for engaging with the target container at a different position;

FIG. 3 includes views (a) to (d), which show the apparatus shown in FIG. 1 in the different stages of de-palletization according to the present invention;

FIG. 4 is a flowchart showing the steps in de-palletising a target container from a pallet;

FIG. 5 includes views (a) to (c), which show a side view of the apparatus shown in FIG. 3 (b to d) in the different stages of de-palletization according to the present invention;

FIG. 6 includes views (a) and (b), which show the apparatus shown in FIG. 1 in the different stages of de-palletisation according to another example of the present invention;

FIG. 7 is an illustration of an adaptation of the apparatus comprising a clamping mechanism for lowering a picked container into a storage bin according to a second embodiment of the present invention;

FIG. 8 includes views (a) to (e), which show the apparatus shown in FIG. 6 in the different stages of de-palletisation according to a second embodiment of the present invention;

FIG. 9 includes views (a) to (c), which show the apparatus shown in FIG. 7 in the different stages of lowering a picked container into a storage bin according to the second embodiment of the present invention;

FIG. 10 is an illustration of an apparatus comprising a clamping mechanism for lowering a picked container according to a third embodiment of the present invention;

FIG. 11 includes views (a) to (e), which show the operation of the apparatus shown in FIG. 9 in the different stages of lowering a container into a storage container according to the third embodiment of the present invention;

FIG. 12 shows an alternative operation of the apparatus shown in FIG. 6 to deposit a target container in a storage bin according to the present invention;

FIG. 13 shows a system for controlling a de-palletisation process using the apparatus according to a present invention;

FIG. 14 shows a palletizing/depalletizing system for controlling a de-palletisation process using the apparatus according to the present invention;

FIG. 15 shows a palletizing/depalletizing system for controlling a de-palletisation process using the apparatus according to the present invention;

FIG. 16 includes views (a) and (b), which are illustrations of an autonomous guided vehicle using the apparatus according to the present invention to de-palletise a pallet;

FIG. 17 is an example of a storage and retrieval system for the storage and retrieval of storage bin in a grid framework structure;

FIG. 18 includes views (a) to (c), which are illustrations of a load handling device operable on the grid framework structure shown in FIG. 17.

### DETAILED DESCRIPTION

The following description describes an apparatus or tool for removing one or more containers, typically layer by layer, from a pallet, otherwise known as a ‘de-palletiser’. That is, each container from a top layer of containers on the pallet is removed before proceeding to removing containers from the next layer (which then becomes the current top layer). As the containers are removed, they may be placed in a given location, such as a conveyor belt to transfer the containers for storage in a warehouse. Typically, the container has a bottom wall and upwardly standing sidewalls extending from the bottom wall to form a box like structure. Examples of containers include various crates or trays such as IFCO (International Food Container Organization) containers that are used to transport fresh fruit and vegetables, meat, fish and seafood, eggs, baked goods, and deli and convenience products.

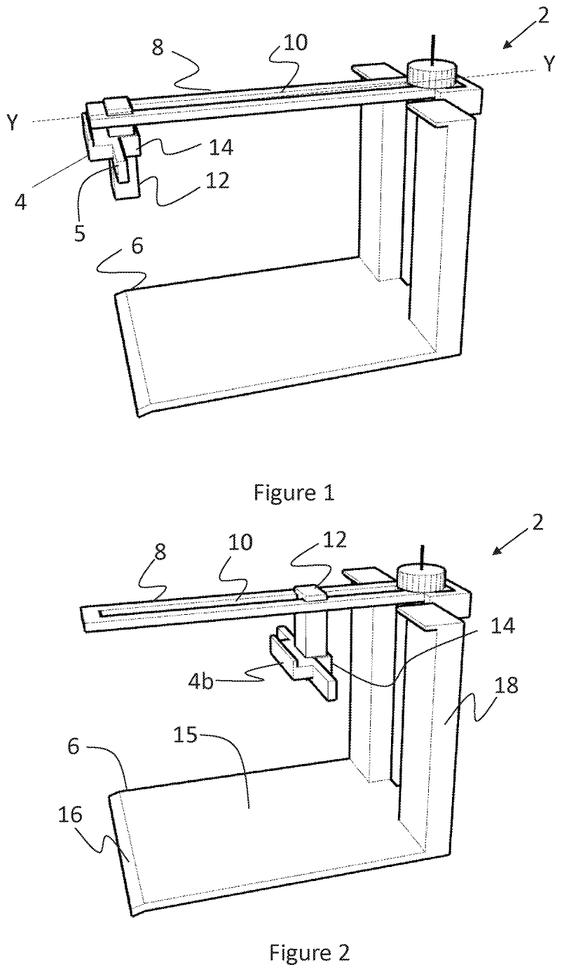

FIGS. 1 and 2 are illustrations of a first example of an apparatus or tool 2 for de-palletising containers stacked in multiple layers on a pallet. The apparatus 2 comprises an engagement feature 4 that is configured to engage with a target container, a pivot member 6 and a guide rail 8 to guide the engagement feature 4 in a substantially horizontal direction relative to the pivot member 6. The apparatus works on the principle of lifting a first end of a target container from a top layer of containers on the pallet such that the target container pivots or tilts about its opposing ‘second’ end on a layer below the top layer or on the pallet. Once tilted, the target container is subsequently pulled by its first end towards the pivot member located below the guide rail 8 by sliding the target container via its pivoted second end on the layer below the target container. Further pulling of the target container causes the second end and thus, the target container to be lifted clear off the pallet by pivoting about the pivot member 6. This “double pivoting” action enables the container to be lifted clear off the pallet for placement in a given location, such as on a conveyor belt for transfer to a warehouse. For the purpose of the present invention, the expression “target container” should be construed in the description and the claims as including any one of the containers on the pallet that has been identified to be removed from the pallet. Typically, such containers are removed layer by layer from multiple containers starting from the top layer.

To enable the target container to be lifted at one end, the engagement feature 4 is able to move in a substantially vertical direction relative to the pivot member 6. In the case of de-palletising one or more containers from a pallet, the engagement feature 4 is raised relative to the pivot member 6 to lift the first end of the container and to pivot the container about its second, rear end. The guide rail 8 is vertically spaced above the pivot member 6 to enable the target container to be pulled onto the pivot member and still be supported at the first end by the engagement feature.

At least one drive mechanism (not shown) can be configured to independently move the engagement feature 4 in both a substantially horizontal direction and a substantial vertical direction relative to the pivot member. Various drive mechanisms known in the art can be used to move the engagement feature 4 in both the horizontal and vertical directions. These include various linear actuators such as mechanical ‘screw’ type actuators and/or ‘hydraulic’ actuators and/or motors. Moreover, the at least one drive mechanism can comprise a first drive mechanism for moving the engagement feature in the substantially horizontal direction along the guide rail and a second drive mechanism for moving the engagement feature in the substantially vertical direction relative to the pivot member. Alternatively, the at least one drive mechanism can be a single drive mechanism with a suitable switching mechanism (e.g. reed switch) to independently move the engagement feature 4 between the horizontal direction and the vertical direction. Movement of the engagement feature 4 in the vertical direction can also enable the apparatus of the present invention to accommodate different size containers. For example, the at least one drive mechanism can be set to move the engagement feature to predetermined heights above the pivot member 6 to accommodate different size containers prior to the apparatus being offered up to the target container.

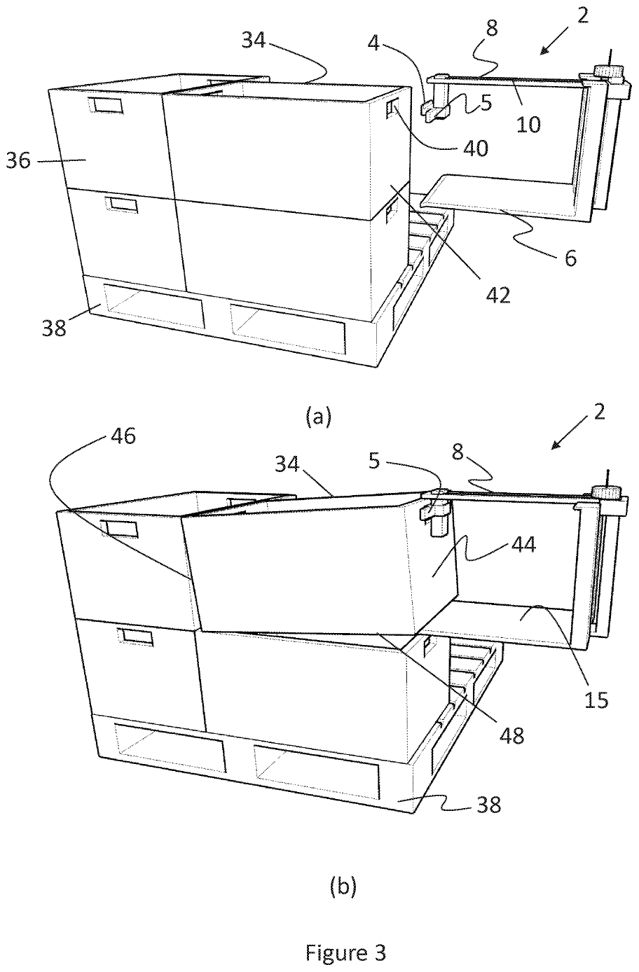

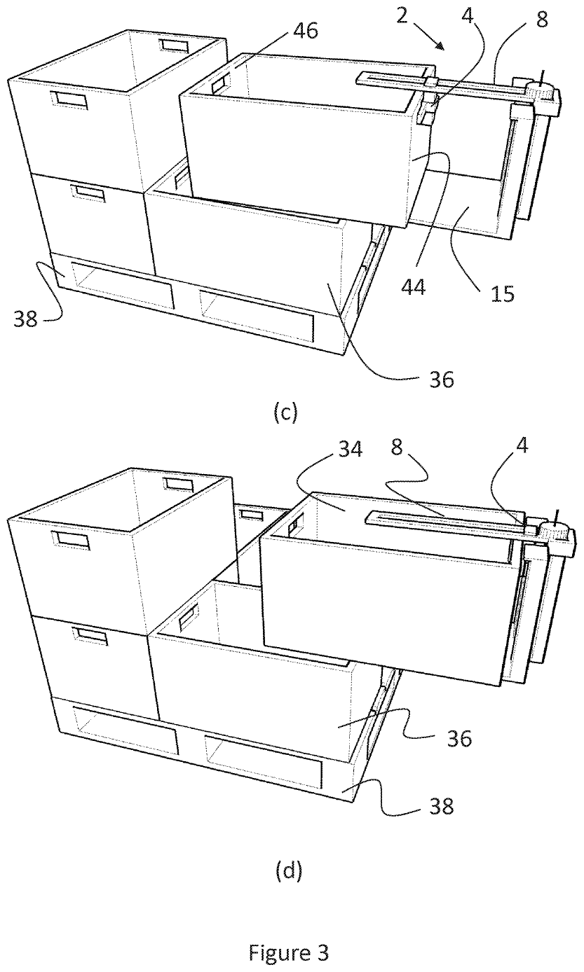

In order to engage with the target container, the engagement feature 4 comprises a suitable grasping feature that physically engages with the container such that when the engagement feature is moved in the vertical direction, the first ‘engagement’ end of the target container is moved in the same vertical direction. While still engaged with the first end of the target container, the engagement feature 4 should also permit the target container to be moved in the substantial horizontal direction towards the pivot member. In the particular embodiment of the present invention shown in FIGS. 1 and 2, the engagement feature 4 comprises a hook 4b that is shaped to be received within an opening, typically used as a handle, in the sidewall of the container, see FIG. 3, view (a). To prevent the hook from pinching delicate items when it is inserted into the opening of the container, the engagement feature further comprises a stop 5 to limit the insertion of the hook into the opening of the container. As can be demonstrated in FIG. 3, view (b), the stop 5 is configured to butt up against the sidewall of the target container when the hook is inserted into the opening in the sidewall of the container. The stop 5 also helps to support the hook 4 when it is engaged with the target container 34.

However, the present invention is not limited to a hook and can be any type of engagement feature that can suitably engage with one end of the target container for it to be lifted when the engagement feature is raised and pulled when moved in the substantially horizontal direction. For example, such engagement features include but are not limited to the use of magnets, e.g. electromagnets that are able to grasp the target container allowing it to be moved in both the vertical and horizontal direction.

When engaged with the sidewall of the target container, the engagement feature 4 is guided to move in a substantial horizontal direction along the guide rail 8 until the bottom wall or the underside of the target container contacts the pivot member 6. Further pulling of the engagement feature 4 causes the target container to pivot about the pivot member 6 at its point of contact with the bottom wall such that the rear end of the target container is lifted clear off the container in the layer below the target container or the pallet. Once lifted clear of the container in the layer below the target container, the target container can be pulled across the pivot member until it is at home in the apparatus where it is supported by both the engagement feature and the pivot member. FIG. 2 is an illustration of the apparatus 2 showing the engagement feature 4 moveable in the longitudinal direction along the guide rail 8 relative to the pivot member. The engagement feature 4 is shown moveably mounted to the guide rail 8 so as to enable the engagement feature 4 to not only move along the guide rail 8 in a substantial horizontal direction along the guide rail 8 but also in a substantial vertical direction relative to the pivot member 6. In the particular embodiment of the present invention shown in FIG. 2, the guide rail 8 comprises an arm comprising an elongated slot 10 extending in a longitudinal direction along the arm. The engagement feature 4 is shown moveable along the slot 10 by being mounted to or attached to a carriage or traveller 12 that is arranged to move along the slot 10. To move in a substantially vertical direction, the engagement feature 4 comprises an attachment 14 that is able to slide in a vertical direction relative to the carriage 12. In the particular example shown in FIGS. 1 and 2, the attachment 14 comprises a sleeve arranged around at least a portion of the carriage 12 and moveable in the vertical direction. The at least one drive mechanism can be configured to move the sleeve 14 in the vertical direction relative to the carriage 12, which in turn moves the engagement feature 4 in the vertical direction relative to the pivot member 6. However, the present invention is not limited to moving the engagement feature 4 relative to the guide rail 8 in order to move the engagement feature 4 in the vertical direction relative to the pivot member 6. Equally or additionally and not shown in FIGS. 1 and 2, movement of the engagement feature 4 in the vertical direction can also be achieved by moving the guide rail 8 supporting the engagement feature in the vertical direction relative to the pivot member 6. Similarly, the at least drive mechanism can be configured to move the engagement feature 4 in the substantially horizontal direction relative to the pivot member 6 by moving the carriage or traveller 12 along the elongated slot 10.

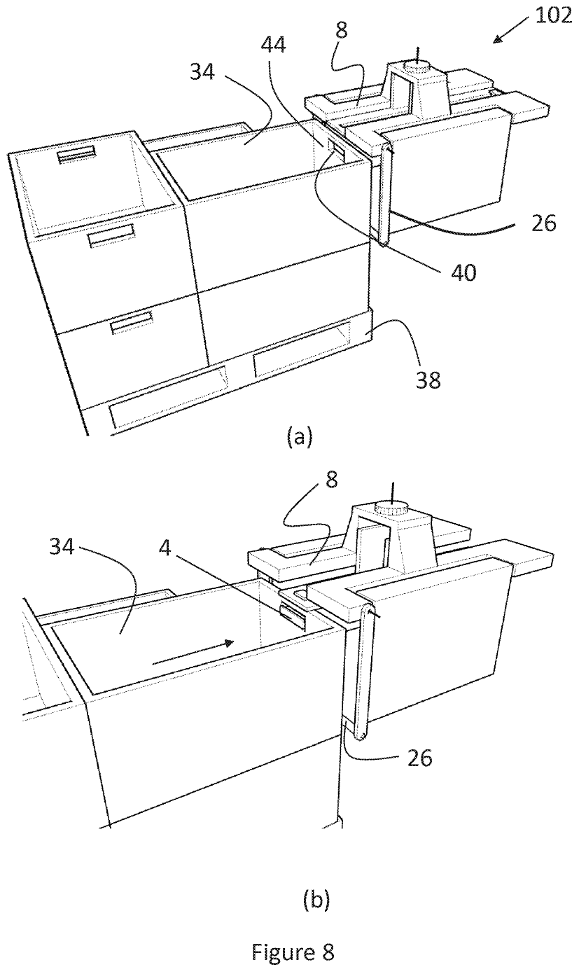

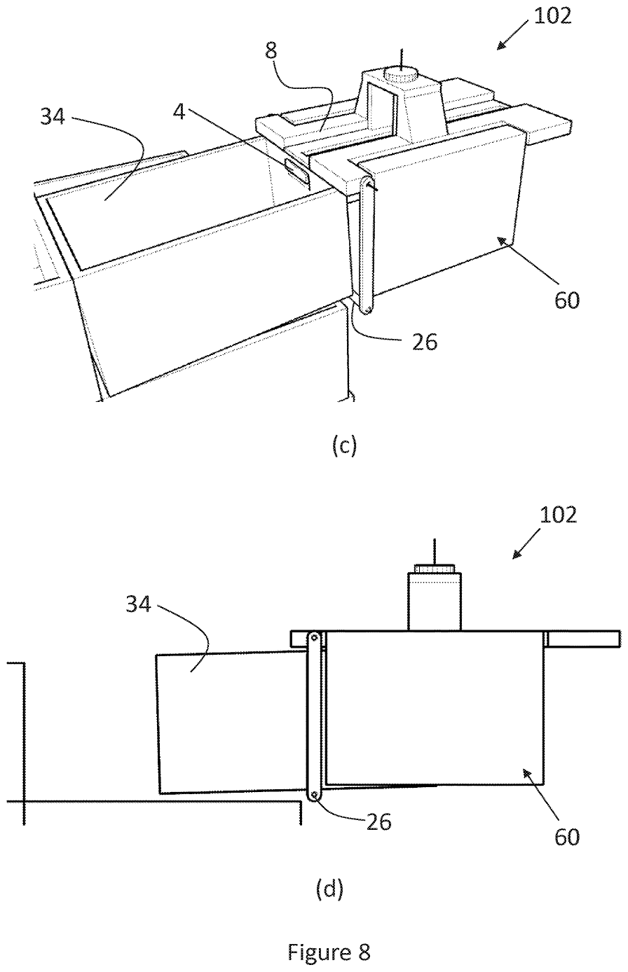

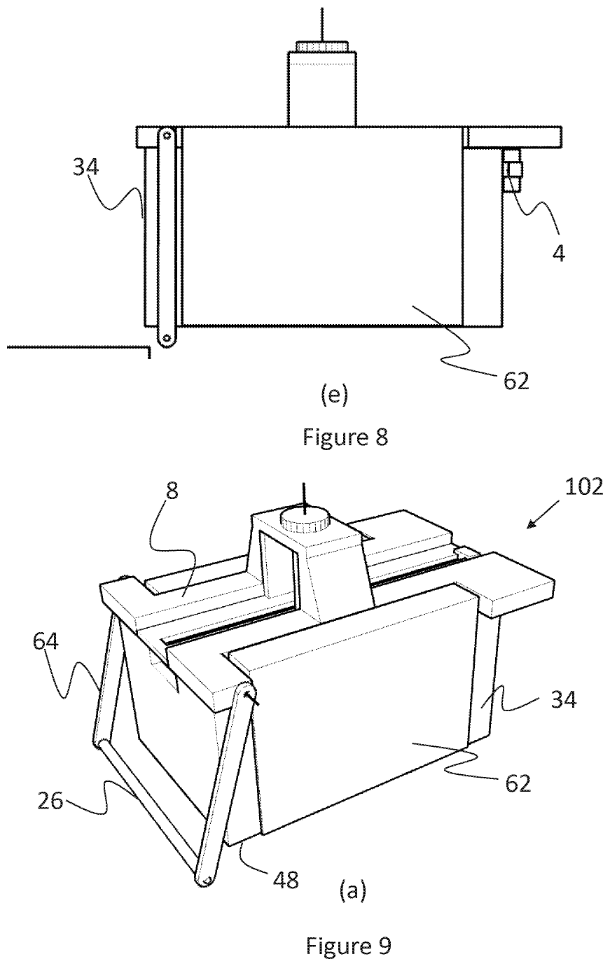

The guide rail 8 extends beyond the pivot member 6 such that the engagement feature 4 is able to engage with the target container prior to being pivoted about the pivot member 6. In the example shown in FIGS. 1 and 2, the pivot member 6 is shown as a support plate 15 having a length that extends longitudinally in a direction parallel to the guide rail 8. The target container is configured to pivot about a leading edge or free edge 16 of the support plate 15 at it is pulled onto the support plate. The leading edge 16 is shown comprising a downwardly extending lip or ramp to prevent the bottom wall of the target container snagging the leading edge of the support plate as it is offered up to the support plate. The support plate 15 provides a resting surface for supporting the target container as it has been pulled across the leading edge of the support plate. The guide rail 8 is shown vertically spaced apart from the pivot member 6 by being mounted to spacers or pillars 18 disposed between the support plate 15 and the guide rail 8. However, the pivot member 6 according to the present invention is not limited to a support plate 15 and can be any support for supporting at least a portion of the target container as it being pulled across the pivot member. For example, the pivot member 6 can be one or more bars or rollers extending across the guide rail 8 in a direction perpendicular to the movement of the engagement feature along the guide rail 8 as shown in FIG. 8, view (b), such that when the target container is pulled onto the bar or roller, the one or more bars or rollers 20 extend across the width of the target container, i.e. the longitudinal axis, X-X, of the one or more pivot bars or rollers extends substantially perpendicular to the longitudinal axis, Y-Y, of the guide rail. The one or more rollers or bars enables the target container to be easily pulled into the apparatus as shown in FIG. 8, views (a) to (e) without any or only minimum (minimal) snagging of the bottom wall of the target container with the pivot member.

However, in comparison to the one or more bars or rollers 20, the support plate 15 can double up as a weighing scale to measure the weight of the target container as it is placed at home in the apparatus. For example, a load cell (not shown) can be placed under the support plate 15 to sense the weight of each container as each container is removed from the pallet. Knowing the tare weight of the target container, the weight of the contents of the target container can thus be deduced. The weight of the contents of the target container can be used to update a stock control database as goods arrive at an inbound area of a warehouse or a fulfilment centre as shown in FIGS. 13, 14 and 15. The weight of each of the containers is measured as they are removed from the pallet and their weight can be compared to a predicted weight based on the quantity of goods ordered from a supplier. If there are any discrepancies in the weight, a notification will be sent to an operator that one or more items in the container could be missing. Alternatively, a message can be sent directly to the supplier informing them of the missing items from the order. To determine the type of item in each of the containers as they are removed from the pallet, the apparatus can further comprise a bar code reader or QR code reader (not shown) to identity the type of goods or SKU (stock control unit) in each of the containers as they are separately removed from the pallet. The data from the bar code reader or QR code reader can be fed to the stock control database.

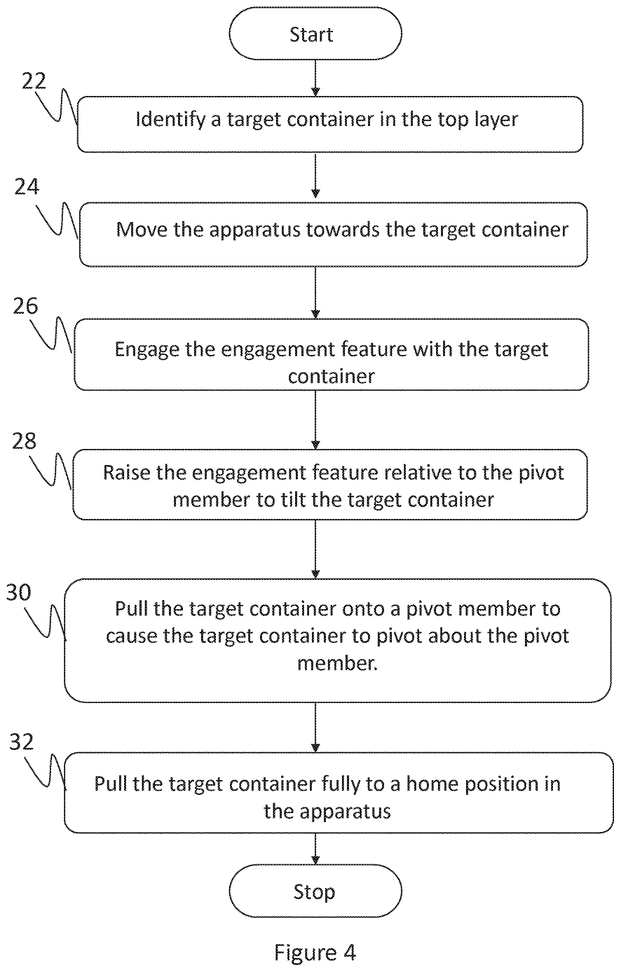

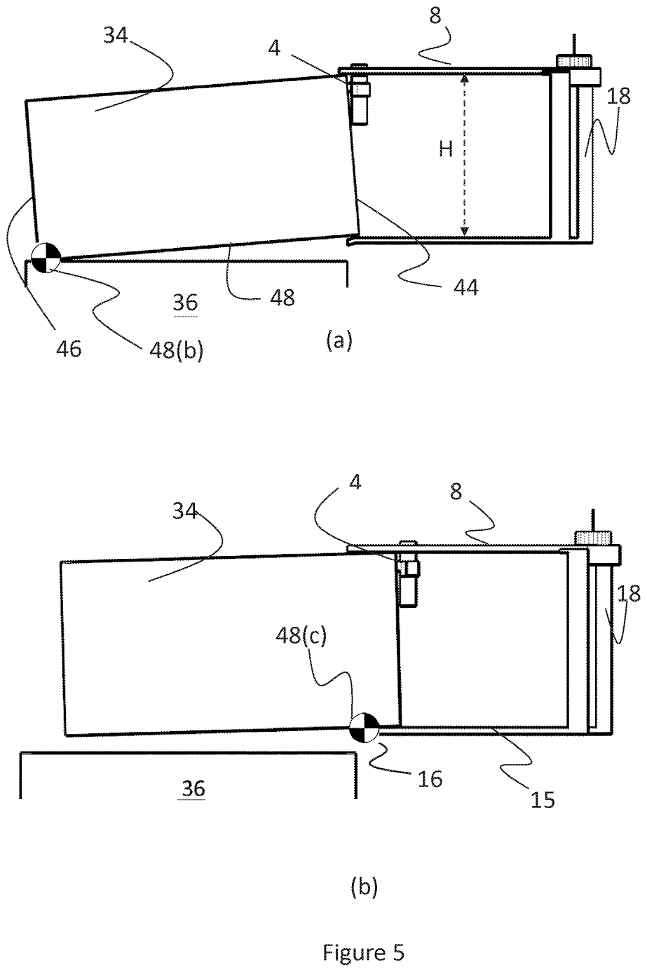

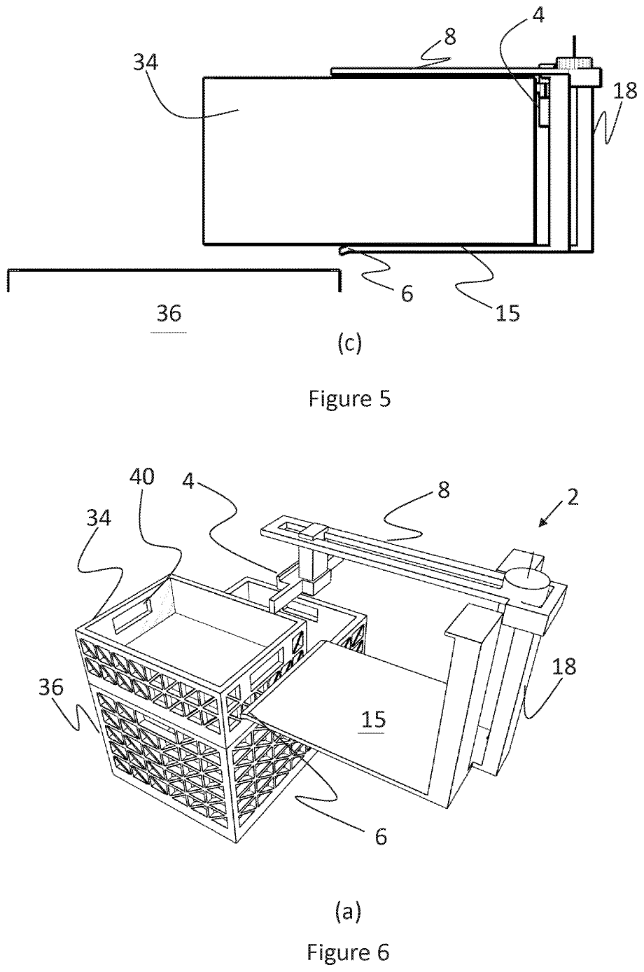

FIG. 3, views (a) to (d), together with a side cross-sectional view of the apparatus shown in FIG. 5, views (a) to (c), and the flowchart shown in FIG. 4 describe the different stages of a picking operation using the apparatus according to the first example of the present invention to remove one or more containers from the pallet, starting from the top layer. In a first stage of the operation shown in FIG. 3, view (a), the apparatus 2 is guided towards a target container 34 in the top layer of containers 36 on a pallet 38. This may involve the use of a vision system (not shown) comprising a camera (not shown) discussed below to take an image of the top layer of the containers on the pallet 38 and a processor or controller in communication with the camera to determine the target container 34 from the top layer to be removed and its current position on the pallet. Once the target container 34 is identified, the engagement feature 4 is moved to an engagement position at the distal end of the elongated slot 10 such that when the apparatus is offered up to the target container 34, the engagement feature 4 is received within an opening 40 in a sidewall of the target container (steps 24 and 26 of FIG. 4). Alternatively, the apparatus can be positioned adjacent to the target container and the engagement feature can subsequently be moved towards the sidewall of the target container such that the engagement feature is received within the opening 40 in the sidewall 42 of the target container 34. The opening 40 is shown in FIG. 3 as being positioned towards the rim of the target container 34 and is typically used as a handle for carrying the container. Examples of such containers where the sidewalls comprise one or more openings include various crates or trays such as IFCO (International Food Container Organization) containers that are used to transport fresh fruit and vegetables, meat, fish and seafood, eggs, baked goods, and deli and convenience products.

The vision system (not shown) can be configured to determine the position of the engagement feature 4 relative to the opening 40 in the sidewall 42 of the target container 34. A controller (or processor) interacts with the vision system to move the engagement feature 4 into alignment with the opening 40 in the sidewall of the target container 34 such that when the apparatus 2 is offered up to the target container 34, the engagement feature 4 is received within the opening 40 in the sidewall 42 of the target container 34, see FIG. 3, view (b). The vision system can be an overhead camera combined with appropriate image processing techniques. The vision system can, as an initiation step and as part of a de-palletisation process, identify a top layer of containers on the pallet 38 as well as to identify the next container with which the apparatus interacts, and monitor the movements of the apparatus as it interacts with the target container. This can be used as a feedback loop to control the movements of the engagement feature. For example, the vision system may be used to select the next most accessible container, such as a corner container, in a layer of containers, and control the movement of the apparatus and thus, engagement feature accordingly.

Once the engagement feature is received within the opening in the sidewall at one end (or first end 44) of the target container, see FIG. 3, view (b) and FIG. 5, view (a), the engagement feature 4 is raised to cause the target container to pivot about an edge at an opposing end (or second end 46) of the target container on a container in a layer below the target container as shown in FIG. 3, view (b) (step 28 of FIG. 4). The pivot action of the target container is indicated in FIG. 5, view (a), by the reference 48 (b). Movement of the engagement feature 4 away from the pallet 38 in a substantially horizontal direction along the guide rail 8 relative to the support plate 15 effectively pulls the target container 34, more specifically the bottom wall 48 of the target container 34, onto the leading edge 16 of the support plate 15 as shown in FIG. 3, view (c), and FIG. 4, view (a) (step 30 in FIG. 4). Further pulling of the engagement feature 4 engaged with the target container along the guide rail 8 causes the target container 34 to pivot about the leading edge 16 of the support plate 15 via its bottom wall 48 resulting in the target container 34, more specifically the second end 46 of the target container 34, to be lifted clear off the container in the layer below as shown in FIG. 3, view (d) and FIG. 5, view (b), until the target container is at home resting on the support plate as shown in FIG. 3, view (d) and FIG. 5, view (c) (step 32 in FIG. 4). For the purpose of the present invention, the term “home” is the stage when the target container is supported by the engagement feature 4 and the pivot member 6 as shown in FIG. 5, view (c). The pivot action of the target container 34 about the pivot member is indicated in FIG. 5, view (b) by the reference 48 (c).

The vision system can also determine the relative height, H, between the engagement feature 4 and the pivot member 6 and to instruct the at least one drive mechanism to vary the height, H, to accommodate different size containers, see FIG. 5, view (a). One of the possible issues with pulling the target container onto the pivot member 6 via a hook received in an opening in the sidewall of the target container 34 is the risk that excessive force may be applied to the sidewall of the target container resulting in damage to the sidewall or at least dismantle the crate. In the case, where the target container is an IFCO crate, largely composed of plastic, the risk of damage to the crate becomes more possible if there is excessive weight in the crate, e.g. greater than 20 kg. To mitigate this problem, the target container 34 can be positioned further along the pivot member 6 to increase the separation between the point of contact with the underside of the target container and the engagement feature 4 before being rotated about the pivot member 6. This can be explained by simple mechanics, where a moment of force to rotate the target container about a pivot is equivalent to the product of the separation between the point of contact with the underside of the target container and the pivot member and the applied force in the vertical direction to the engagement feature. The greater the distance between the point of contact with the underside of the target container and the pivot member, the lesser the force needed to rotate the target container about the pivot member and vice-versa. To increase the separation between the point of contact with the underside of the target container and the pivot member, the height, H, between the engagement feature and the pivot member can be increased beyond the height of the target container to the extent that the pivot member is required to move further along the underside of the target container before contact is established. Thus, in addition to the apparatus 2 being configured to pull the target container 34 across the pivot member 6, the apparatus can also be configured to push the pivot member 6 against the underside of the target container simultaneously or at the same time. There is a momentary position where the target container is stationary and occurs when there is an equilibrium between pulling and pushing force of the engagement feature and the pivot member 6 respectively. At this position, any excessive force applied to the engagement feature in the horizontal direction and/or vertical direction relative to the pivot member 6 causes the target container 34 to rotate about the pivot member and therefore, lifted clear from the pallet.

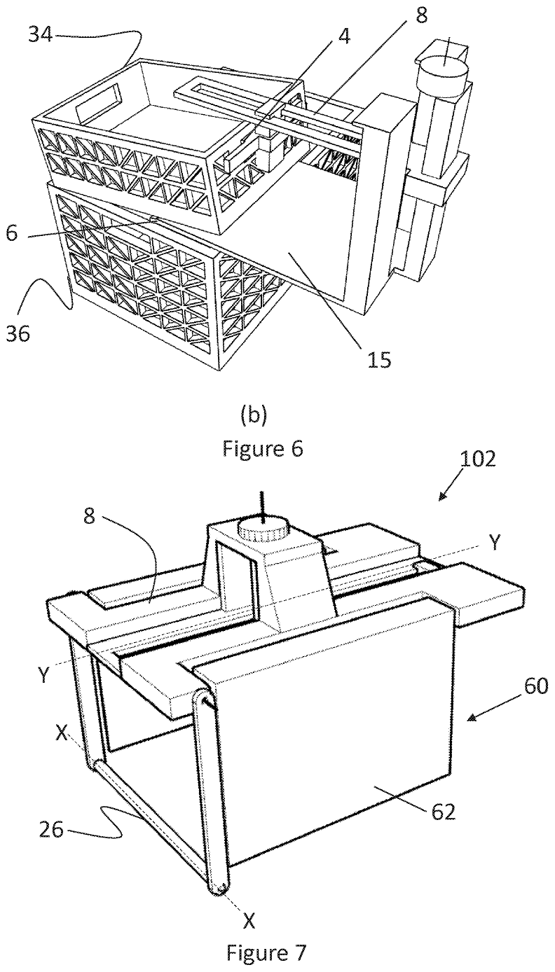

One of the main advantages of pulling on the engagement feature and pushing on the pivot member against the target container is to support the target container when it is being lifted off a container 36 in the layer below. In some instances, various size containers can be stacked on a pallet and as a result they are stacked in different orientations as shown in FIG. 6, views (a) and (b). Merely, pulling on a smaller target containers onto the pivot member 6 may cause one of the corners of the target container 34 to drop into the container below and therefore, become unsupported by the engagement feature. To mitigate this problem, the pivot member 6 is pushed towards the underside of the target container when the engagement feature 4 lifts the first, front end of the target container 34 so as to support the target container as it is being pulled onto the pivot member as shown in FIG. 6, view (b). This push and pull action of the engagement feature and the pivot member respectively supports the target container as it is being removed from the pallet.

The sequence of the movements of the engagement feature along the guide rail 8 and vertically relative to the pivot member 6 to pick one or more containers from the pallet can be controlled by a controller (or processor). For example, one or more processors and memory storing instructions that when executed by the one or more processors can cause the at least one drive mechanism to control the sequence of movements of the engagement feature along the guide rail and vertically relative to the pivot member to pick up one or more containers from a stack of containers on a pallet.

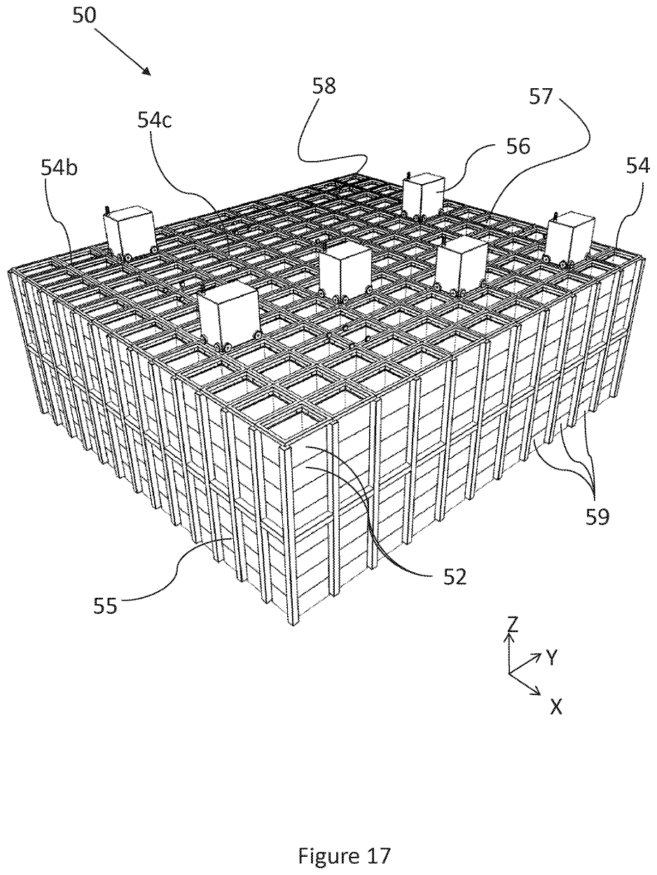

In a second example of the present invention, the apparatus 102 can be adapted to deposit one or more containers into a larger storage container otherwise known as a hive tote or storage bin for storage in a storage and retrieval system. To provide clarity and to differentiate from the term “container” on the pallet, the term “storage bin” will be used to describe the storage containers used to store items in a storage and retrieval system. Such storage and retrieval systems can comprise a three-dimensional storage grid framework structure, within which storage containers/bins/totes are stacked on top of each other in one or more storage columns. PCT Publication No. WO2015019055A (Ocado) describes a known storage and retrieval or distribution system 50 in which stacks of storage bins 52 are arranged within a grid framework structure 54. The storage bins 52 are accessed by load handling devices 56 remotely operative on tracks 58 located on the top of the grid framework structure 54. A system of this type is further discussed below and illustrated schematically in FIG. 17 of the accompanying drawings.

To adapt the apparatus or tool of the present invention to deposit one or more containers removed from a pallet into a storage bin for storage in a storage and retrieval system, the apparatus further comprises a clamping mechanism 60 comprising a pair of clamping plates 62 downwardly extending from the guide rail 8 as shown in FIG. 7. Like the first example of the apparatus 2, the apparatus 102 according to the second example comprises an engagement feature configured to engage with the sidewall of a target container in the top layer of containers on a pallet, a guide rail 8 for moving the engagement feature in a substantial horizontal direction, a pivot member 26 for causing the target container to be pivoted about the pivot member 26 and thereby, lifted clear off the pallet. The de-palletising operation starting from the top layer is similar to the de-palletising operation described above with reference to the flowchart shown in FIG. 4. With reference to FIG. 8, views (a) to (e), the “double pivot” action of the de-palletising operation according to the present invention begins with the apparatus 102 identifying a target container 34 in the top layers of containers on the pallet, offering up the apparatus 102 to a target container on a pallet such that the engagement feature 4 is aligned with an opening 40 in the sidewall 44 of the target container 34, moving the engagement feature 4 along the guide rail 8 in a substantially horizontal direction such that engagement feature 4 is received within the opening 40 and raising the engagement feature relative to the pivot member to cause the target container to tilt on the container in the layer below the top layer. The target container 34 is subsequently pulled across the pivot member 26 until the target container 34 is at home in the apparatus 102 where it is supported by both the engagement feature 4 and the pivot member 26.

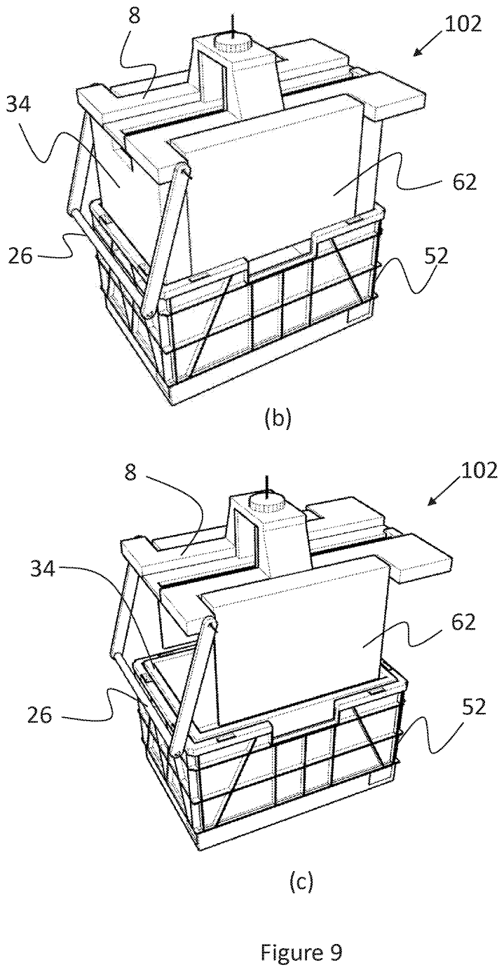

Instead of a support plate 15 in the first example of the apparatus 2 shown in FIGS. 1 to 5, the pivot member 26 in the second example of the apparatus comprises a bar or roller extending across the clamping mechanism 60 as shown in FIG. 7. The use of a bar or roller bar 26 instead of a support plate 15 to pivot to the target container 34 will be become more apparent when describing the use of the apparatus to lower the target container into a storage container. FIG. 8, views (a) to (e) illustrate the use of the apparatus according to the present invention to deposit or lower a target container into a storage bin once the target container is supported by both the pivot bar 26 and the engagement feature 4. To lower the target container into the storage bin, the target container must be released from the pivot member 26 and the engagement feature 4. Thus, in a first operation of depositing a target container into the storage bin, the clamping mechanism 60 is actuated to provide a clamping force to hold the target container between the clamping plates. This enables the pivot member 26 and the engagement member 4 to disengage from the target container. In comparison to the support plate 15 discussed above, the pivot bar or roller 26 enables the pivot member to be moved to a position from supporting the bottom wall 48 of the target container 34 to a position where it is not supporting the bottom wall of the target container. In the example shown in FIG. 8, view (a), the pivot bar or roller 26 is pivotally mounted to the guide rail and moveable between a support position supporting the bottom wall of the target container as shown in FIG. 8, view (e), and a release position not supporting the bottom wall 48 of the target container 34 as shown in FIG. 9, view (a). The mounting of the pivot bar or roller to the guide rail comprises two arms 64, each having a first end pivotally mounted to the guide rail 8 and a second end connected to a distal end of the pivot bar or roller 26.

To deposit or lower the target container into the hive tote, the target container is moved to a position above the mouth or opening of the storage bin such that when the target container is released, the target container falls into the hive tote, see FIG. 9, view (b). The vision system discussed above can be used to align the target container above the storage bin at a given location such as a conveyor belt for subsequent transfer to a warehouse or storage and retrieval system. The controller (or processor) interacts with the vision system to move the target container into alignment with the opening or mouth of the storage bin such that the target container can be lowered into the storage bin as demonstrated in FIG. 9, view (b). The release position corresponds to the pivot bar or roller 26 being moved to a position away from the bottom wall of the target container as shown in FIG. 9, view (b). Any suitable rotatory drive mechanism can be used to move the pivot member between the support position and the release position. In the particular example of the present invention shown in FIG. 9, views (a) to (c), the rotatory drive mechanism moves the pivot bar or roller 26 via rotation of the two connecting arms 64 in a substantially horizontal direction away from the bottom wall of the target container such that the pivot bar or roller no longer supports the target container. Movement of the pivot bar or roller away from the bottom wall of the target container also prevents the pivot bar or roller clashing with the rim of the storage container when the target container is positioned above the storage container.

An operation in reverse to engaging the engagement feature with the sidewall of the container can be used to release the engagement feature from the target container, i.e. lowering the engagement feature followed by withdrawing the engagement feature from the sidewall of the target container in a substantially horizontal direction.

Once the target container is released from both the pivot member and the engagement feature, release of the target container from the apparatus is very much dependent on the clamping force of the target container between the pair of clamping plates 62. The clamping force can be controlled so as to control the speed of descent of the target container into the storage bin. As the clamping force is gradually reduced, friction between the exterior surface of the target container 34 and the clamping plates 62 reduces causing the target container to drop under its own weight, see FIG. 9, view (c). Slow descent of the target container is particularly important where the contents of the target container comprises fragile items or to prevent damage to either the target container or the hive tote.

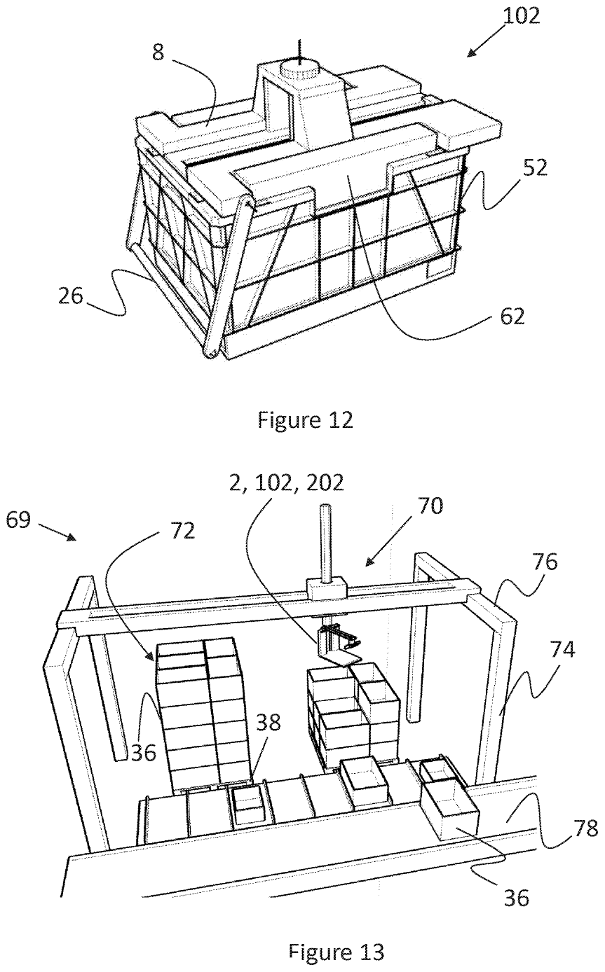

The apparatus can alternatively lower the target container into the storage container while still being clamped between the pair of clamping plates as shown in FIG. 12. In this operation, the pivot bar or roller 26 is sufficiently moved away from the sidewall of the storage bin 52 to prevent the pivot bar or roller 26 clashing with the storage bin 52 when the target container 34 is lowered into the storage bin 52. The clamping mechanism is subsequently released once the target container is seated in the storage bin. The spacing between the exterior of the sidewall of the target container and the storage container is sufficient for the pair of clamping plates 62 to release the target container 34 in the storage bin 52.

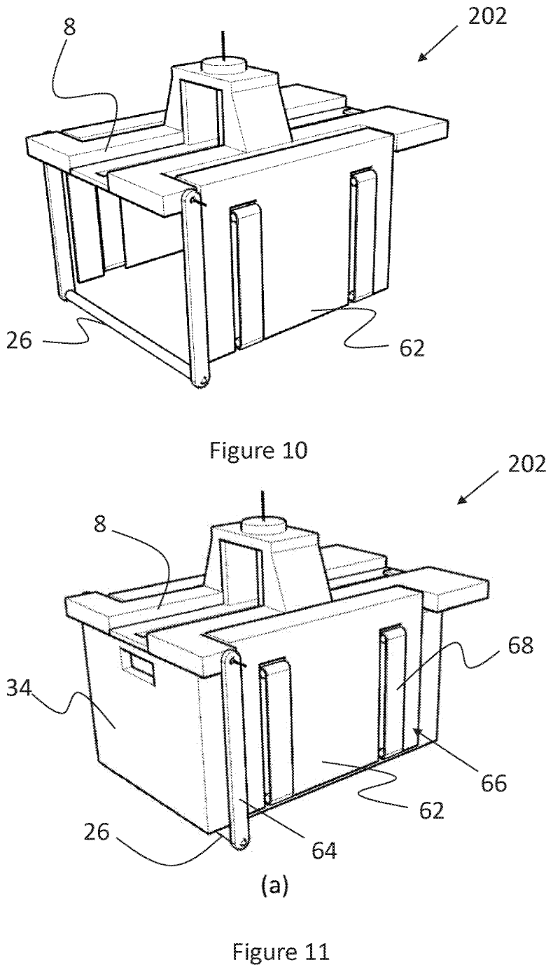

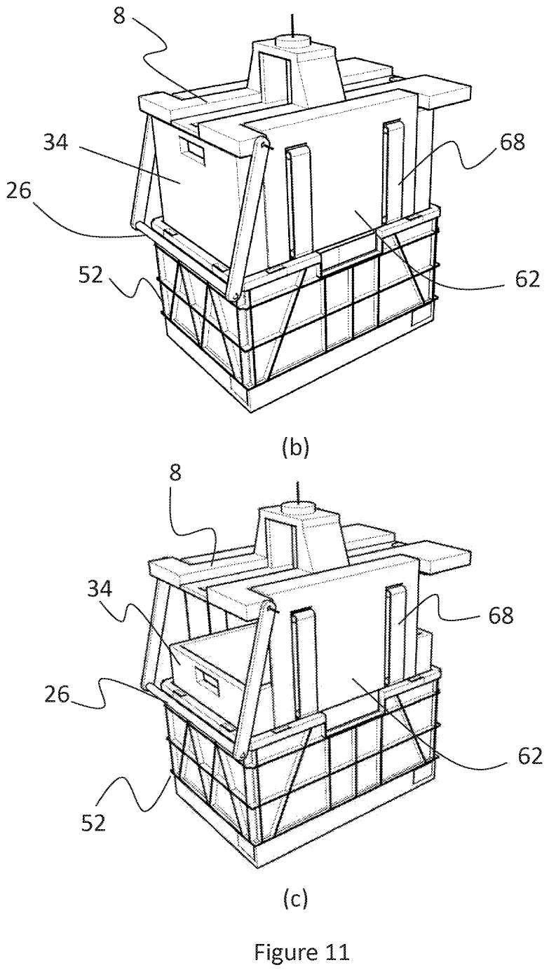

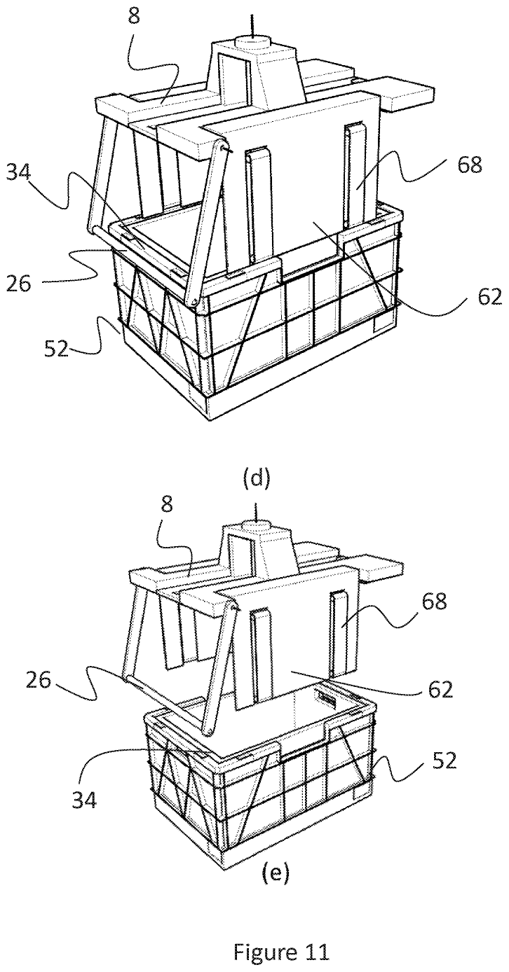

In addition to or alternative to controlling the clamping force to control the descent of the target container into the storage bin, the clamping mechanism 60 can comprise a conveying belt mechanism 66 that engages with the exterior surface of the target container 34 to control the speed of descent of the target container 34 into the storage bin as shown in another example of the apparatus 202 in FIG. 10. Each of the pair of clamping plates 62 comprise one or more conveying belts 68 extending in a vertical direction along at least a portion of the height of the clamping plates 62. The one or more conveying belts 68 are driven by a belt drive mechanism to move the conveying belt 68 vertically around an endless loop. The target container 34 is clamped between the pair of clamping plates 62 such that the one or more conveying belts 68 in each of the clamping plates 62 engages with the exterior surface of the sidewalls of the target container. The operation to control the descent of the target container shown in FIGS. 11, views (a) to (e), begins with releasing the target container 34 from the engagement feature and the pivot bar or roller 26 as shown in FIG. 11, views (a) and (b), such that the target container 34 is primarily supported by the clamping mechanism 60. The descent of the target container 34 is controlled by driving rotation of the one or more conveying belts vertically in a controlled manner as shown in FIG. 11, views (c) to (e). As the pivot bar or roller 26 no longer supports the bottom wall of the target container 34, the target container is able to be lowered when the belt drive mechanism drives rotation of the one or more belts vertically in one rotational direction, e.g. anti-clockwise direction. The speed of rotation of the conveying belts controls the speed of descent of the target container into the storage container.

The apparatus of the present invention can be employed in a system 69 comprising a pallet unloading station 72 for receiving one or more pallets of containers, a robotized de-palletiser 70 equipped with the apparatus or tool 2, 102, 202 described above with reference FIGS. 1 to 12 for picking one or more containers layer by layer on a pallet, starting from the top layer and for transferring the containers to a given location such as a conveyor 78 for transferring to a warehouse or storage and retrieval system as taught in WO2015019055 (Ocado) and detailed below. The robotized de-palletiser 70 can be assisted by a vision system (not shown) as discussed above for identifying a target container on the pallet 38 and guiding the apparatus to pick up a target container from the pallet and transfer the target container to a given location. Various robotized devices can be used to robotize the de-palletizing operation. In the first example of the robotized de-palletiser shown in FIG. 13, a gantry 74 can be equipped with the apparatus or tool 2, 102, 202 of the present invention for unloading one or more containers from the pallet 38 in the pallet unloading station 72. The gantry 74 comprising a frame 76 that is configured to move the apparatus or tool 2, 102, 202 in multiple orthogonal directions, namely X, Y and/or Z Cartesian directions. In addition to moving the apparatus in multiple orthogonal axes, the apparatus can optionally be rotated about a vertical axis. The gantry 74 is shown in FIG. 13 in the unloading station 72 positioned adjacent to the pallets and a conveyor 78 so that the apparatus or tool 2, 102, 202 is within easy reach of the containers on the pallet and the conveyor 78. By virtue of the multi-axes robot, the gantry 74 can be instructed to move the apparatus or tool 2, 102, 202 to remove one or more containers from the pallet and transfer the one or more containers to a given location such as a conveyor 78 for subsequent transfer to a warehouse or a storage and retrieval system. The one or more containers removed from the pallet can either be deposited directly on the conveyor 78 or alternatively, the apparatus 2, 102, 202, incorporating the clamping mechanism 60 can deposit the container into a storage bin for subsequent transfer to the storage and retrieval system. In addition to controlling the at least one drive mechanism of the apparatus, the controller can control the gantry, in particular a drive system of the gantry, to move the apparatus in multiple orthogonal axes to offer up the apparatus to a target container identified by the vision system on the pallet for transfer to the given location.

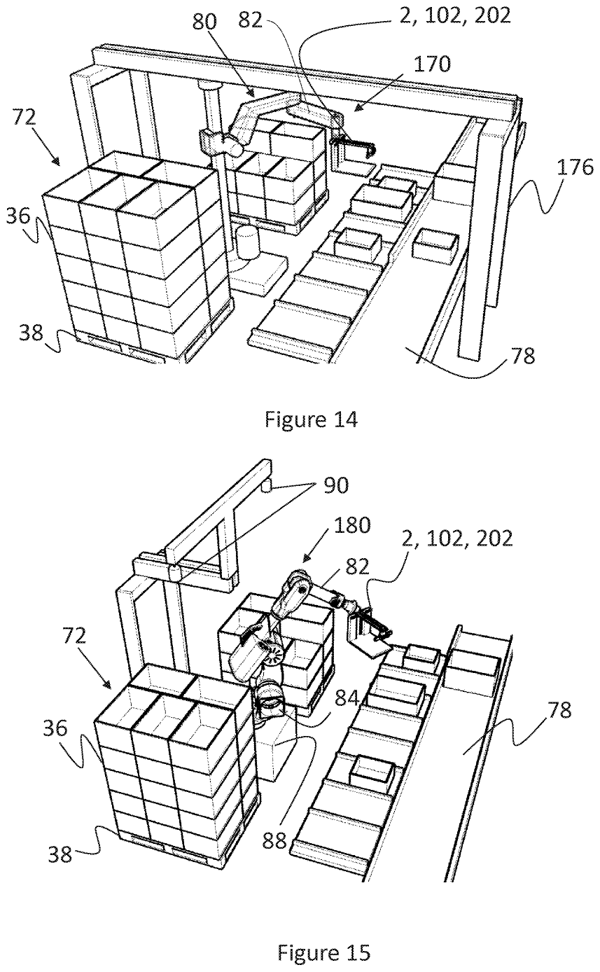

In a second example of the robotized de-palletiser 170 shown in FIG. 14, the apparatus of the present invention can be configured to be mounted to SCARA robot (Selective Compliance Assembly Robot Arm or Selective Compliance Articulated Robot Arm) to provide greater reach to the containers on the pallet and the conveyor 78 via a robotic arm 80. The SCARA robot is shown mounted to a frame 176 and comprises parallel arms connected by an elbow or moveable joint to enable movement of the apparatus in multiple configurations. The robotized de-palletiser 180 shown in FIG. 15 is an example where the robot 80 is a six-axes robot enabling multiple movements of the end effector in x, y, and z planes. Unlike the example shown in FIG. 14, the robot base 84 is mounted on a plinth 88. Also shown in FIG. 15, are overhead cameras 90 of the vision system used by the controller to control the movement of the robotized de-palletiser. In comparison to the six-axes robot, the SCARA robot illustrated in FIG. 14 provides faster speed and greater reach to the containers on the pallet.

In both examples shown in FIGS. 14 and 15, the robotic arm 82 comprising the apparatus or tool mounted thereto is positioned within easy reach of the pallet 38 and a conveyor 78 for transferring the container picked from the pallet to a warehouse or a storage and retrieval system. As with the first example of the robotized palletiser, the movements of the end effector and thus, apparatus can be controlled by a controller to offer up the apparatus to a target container on the pallet and subsequently, transferring the target container to a conveyor.

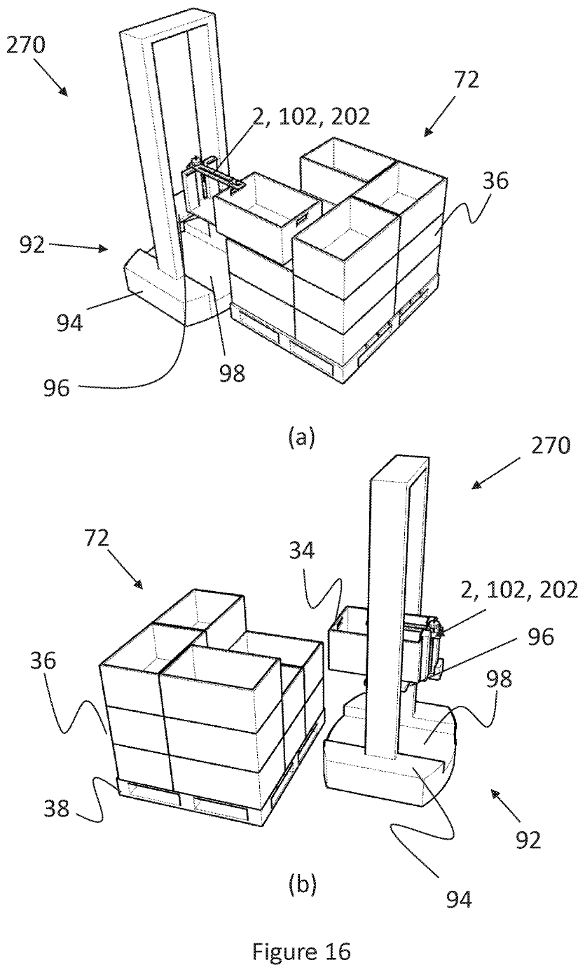

In both the first and second examples of the robotized de-palletiser 80, 180, the apparatus would need to be within easy reach of the pallet and the conveyor for transferring the container removed from the pallet for subsequent storage in a warehouse or a storage and retrieval system. In some fulfilment centres, goods arriving at an inbound area of the fulfilment centre, e.g. the pallet unloading station, is located in a different location to a storage facility in the warehouse or the storage and retrieval system to the extent they are not within easy reach of each other. In a third example of the robotized de-palletiser 270, a vehicle 92, namely an autonomous guided vehicle (AGV), can be equipped with the apparatus of the present invention as shown in FIG. 16, views (a) and (b). The vehicle 92 comprises a body 94 comprising a drive assembly (not shown) for moving the vehicle 92, e.g. a wheel assembly and a drive mechanism for driving the wheel assembly. The drive assembly can transport the apparatus to the pallet unloading station, wherein the apparatus mounted to the vehicle can identify and pick a target container from the pallet. The vehicle can subsequently transport the target container into a storage facility in the warehouse or the storage and retrieval system. In the example shown in FIG. 16, views (a) and (b), the robotized de-palletiser 270 comprises a lifting mechanism 96 for lifting and lowering the apparatus 2, 102, 202 depending on the position and/or size of a target container 34 on the pallet 38. Once picked from the pallet, the lifting mechanism 96 can lower the target container onto a seating area 98 on the vehicle body 94 to increase the stability of the vehicle when being maneuvered around the fulfilment centre. The vehicle 92 can be guided by markers around the fulfilment centre. For example, the vehicle 92 can comprise a location recognition sensors (not shown) for detecting a location of the vehicle in a travelling direction and a controller can be configured to move the vehicle in response to one or more signals from the location recognition sensor. The location recognition sensor can comprise a light detection and ranging (LiDAR) sensor comprising a laser beam source, an optical receiver and a scanning system for deflecting a laser beam generated by the laser beam source in at least two scanning directions. While not shown in FIG. 16, views (a) and (b), the vehicle 92 can also double up as a pallet mover and be equipped with a plurality of forks outwardly extending from the body 94 of the vehicle and a lifting mechanism for lifting and handling pallets.

The robotized de-palletizing systems discussed above allow containers to be removed from a pallet for subsequent transfer to the storage and retrieval system. An example of a storage and retrieval is a storage and retrieval system comprising a grid framework structure comprising a plurality of storage columns 59 for the storage of a plurality of storage bins 52 in multiple stacks of storage bins. One or more robotic load handling devices 56 operable on the grid framework structure 54 is able to retrieve a storage bin 52 from a given storage column 59. A typical storage and retrieval system 50 is taught in WO2015019055 (Ocado) and corresponding U.S. Pat. No. 10,000,337 (Ocado Innovations Limited), the entire content of which is incorporated herein by reference, and shown in FIG. 17. In detail, the grid framework structure 54 comprises a plurality of vertical uprights or upright members or upright columns 55 that support horizontal grid members 54b, 54c. A first set of parallel horizontal grid members 54b is arranged perpendicularly to a second set of parallel horizontal grid members 54c to form a grid structure or grid 58 comprising a plurality of grid cells 57. Each grid cell in the grid framework structure has at least one grid column for storage of a stack of storage containers, otherwise known as hive totes. For the avoidance of doubt, the term “grid framework structure” is used to mean a three-dimensional structure within which the storage containers are stored, and the terms “grid structure” and “grid” are used interchangeably to mean the two-dimensional structure in a substantially horizontal plane upon which the load handling devices operate. The grid cell has an opening to allow a load handling device to lift a storage container or hive tote through the grid cell. In the grid structure, the first set of parallel horizontal grid members 54a intersect the second set of parallel horizontal grid members 54b at nodes. The grid structure is supported by the upright members 55 at each of the nodes or at the point where the grid members intersect such that the upright members are interconnected at their tops ends by the intersecting grid members. The grid members 54b, 54c, 55 are typically manufactured from metal and typically welded or bolted together or a combination of both. The storage bins 52 are stacked between the upright members 55 of the grid framework structure 54, so that the upright members 55 guard against horizontal movement of the stacks of bins 52, and guide vertical movement of the storage bins 52. The top level of the grid framework structure 54 includes rails or tracks arranged in a grid pattern across the top of the stacks to define a track system. The rails support a plurality of load handling devices 56. The track system comprises a first set of parallel rails to guide movement of the robotic load handling devices 356 in a first direction (for example, an X-direction) across the top of the grid framework structure 54, and a second set of parallel rails, arranged perpendicular to the first set, to guide movement of the load handling devices 56 in a second direction (for example, a Y-direction), perpendicular to the first direction. In this way, the rails allow movement of the robotic load handling devices 56 laterally in two dimensions in the horizontal X-Y plane, so that a load handling device 56 can be moved into position above any of the stacks of storage bins 52.

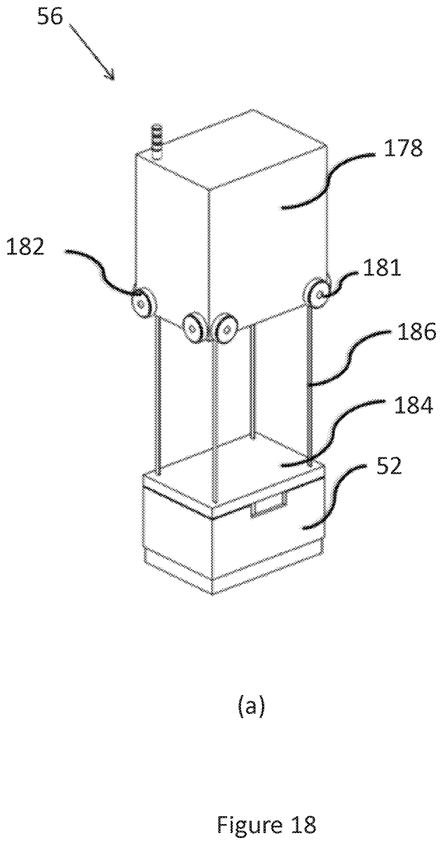

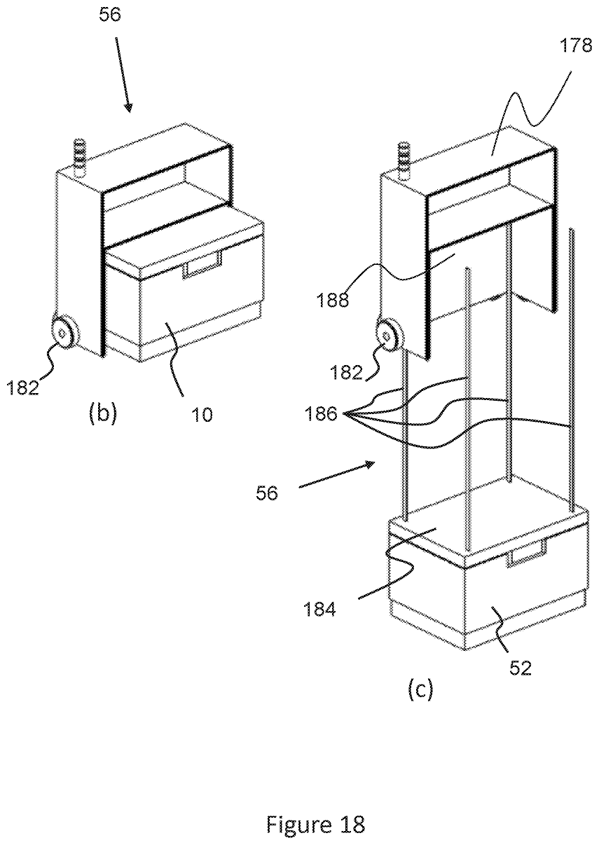

A known load handling device otherwise known as a bot 56 shown in FIG. 18, views (a) to (c), comprising a vehicle body 178 is described in PCT Patent Publication No. WO2015/019055 (Ocado Innovation Limited) and corresponding U.S. Pat. No. 10,000,337 (Ocado Innovations Limited), the entire content of which is incorporated herein by reference, where each load handling device 56 only covers a single grid space or grid cell of the grid framework structure 54. Here, the load handling device 56 comprises a wheel assembly comprising a first set of wheels 181 consisting of a pair of wheels on the front of the vehicle body 178 and a pair of wheels 181 on the back of the vehicle 178 for engaging with the first set of rails or tracks to guide movement of the device in a first direction, and a second set of wheels 182 consisting of a pair of wheels on each side of the vehicle 178 for engaging with the second set of rails or tracks to guide movement of the device in a second direction. Each of the sets of wheels are driven to enable movement of the vehicle in X and Y directions respectively along the rails. One or both sets of wheels can be moved vertically to lift each set of wheels clear of the respective rails, thereby allowing the vehicle to move in the desired direction, e.g. X or Y direction on the grid structure.

The load handling device 56 is equipped with a lifting device or crane mechanism to lift a storage container from above. The crane mechanism comprises a winch tether or cable 186 wound on a spool or reel (not shown) and a grabber device 184 in the form of a lifting frame. The lifting device comprises a set of lifting tethers 186 extending in a vertical direction and connected nearby or at the four corners of the lifting frame 184, otherwise known as the grabber device (one tether near each of the four corners of the grabber device) for releasable connection to a storage bin 52. The grabber device 184 is configured to releasably grip the top of a storage bin 52 to lift it from a stack of containers in a storage system of the type shown in FIG. 17.

The wheels 181, 182 are arranged around the periphery of a cavity or recess, known as a container-receiving recess or container receiving space 188, in the lower part. The recess is sized to accommodate the storage bin 52 when it is lifted by the crane mechanism, as shown in FIG. 16(a) to (c). When in the recess, the storage bin is lifted clear of the rails beneath, so that the vehicle can move laterally to a different location. On reaching the target location, for example another stack, an access point in the storage and retrieval system or a conveyor belt, the bin or container can be lowered from the container receiving portion and released from the grabber device. The container receiving space may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS) in which case the container receiving space is located below a cantilever of the load handing device. In this case, the grabber device is hoisted by a cantilever such that the grabber device is able to engage and lift a container from a stack into a container receiving space below the cantilever.

It is understood that the apparatus of the present invention is not limited to a de-palletiser and the apparatus can equally be used in reverse to palletise a pallet, i.e. placing containers, typically one by one on the pallet. For example, the apparatus can be instructed to remove one or more containers from a given location (e.g. conveyor) for placement on a pallet. The de-palletising operation described with reference to the flowchart shown in FIG. 4 can be used to pick-up one or more containers from the given location. Once held by the apparatus, the container can be transferred to the pallet. Releasing the container onto the pallet involves pushing the container via the engagement feature across the pivot member towards the pallet. This is exemplified by the steps shown in FIG. 5, views (a) to (c), but in reverse.

The apparatus is positioned adjacent the pallet such that when the engagement feature is moved forward in a substantial horizontal direction along the guide rail, the container is pushed onto a top layer on the pallet or directly on the pallet. As can clearly be shown in FIG. 5, view (a), pushing the container across the pivot member causes the end of the container not engaged with the engagement feature (second end) to tip onto the container in the layer below. Further movement of the engagement feature away from the pivot member eventually causes the end engaged with the engagement feature (first end) to be not supported by the pivot member. The container can be lowered onto the container in the layer below by lowering the engagement feature in a substantial vertical direction. In the case, where the engagement feature is a hook as discussed above, further lowering of the engagement feature in the substantial vertical direction disengages the engagement feature from the sidewall of the container. The engagement feature can be subsequently retracted away from the sidewall of the container.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

What is claimed is:

1. An apparatus for unloading or loading one or more containers of a plurality of containers stacked up in multiple layers on a pallet, each of the plurality of containers comprising a bottom wall and upwardly standing sidewalls, the apparatus comprising:
(a) a pivot member for supporting a container; and
(b) a guide rail arranged above the pivot member, the guide rail supporting an engagement feature for engaging with a sidewall of a target container, the engagement feature is moveable in a substantially horizontal direction along the guide rail relative to the pivot member;
wherein the engagement feature is configured such that there is relative vertical movement between the engagement feature and the pivot member, in use, when the engagement feature is engaged with the sidewall of the target container, movement of the engagement feature in the vertical direction relative to the pivot member causes the target container to tilt on a container in a layer immediately below the target container or on the pallet and relative movement between the engagement feature and the pivot member in the substantially horizontal direction causes the target container to pivot about the pivot member as it is moved onto or removed from the pivot member.

2. The apparatus of claim 1, wherein the guide rail comprises an arm, said engagement feature is moveable in a longitudinal direction along the arm.

3. The apparatus of claim 1, wherein the guide rail is guided to move in the vertical direction relative to the pivot member by a substantially vertical guide member.

4. The apparatus of claim 3, wherein the engagement feature is moveably mounted to the guide rail to move in a substantial vertical direction relative to the guide rail.

5. The apparatus of claim 1, wherein the guide rail extends in a longitudinal direction beyond the pivot member such that the engagement feature is moveable beyond the pivot member when engaging with the target storage container.

6. The apparatus of claim 1, wherein the engagement feature comprises a hook receivable in an opening in one or more sidewalls of the container.

7. The apparatus of claim 6, wherein the engagement feature comprises a stop that is configured to butt up against the one or more sidewalls comprising the opening to limit the movement of the hook when the hook inserted into the opening of the sidewall of the container.

8. The apparatus of claim 1, wherein the pivot member comprises the leading edge of a support platform having a longitudinal axis parallel to the movement of the engagement feature along the guide rail, wherein the leading edge is configured to contact the target container when the target container is pulled onto the support platform so as to cause the target container to pivot about the leading edge.

9. The apparatus of claim 8, wherein the leading edge of the support platform comprises a roller rotatable about an axis substantially perpendicular to the movement of the engagement feature along the guide rail.

10. The apparatus of claim 8, further comprising a load cell configured to measure the weight of the target container on the support platform.

11. The apparatus of claim 1, wherein the pivot member comprises a roller or a bar having a longitudinal axis extending in a direction perpendicular to the movement of the engagement feature along the guide rail.

12. The apparatus of claim 11, wherein the pivot member is moveable relative to the pivot member in a direction parallel to the movement of the engagement feature along the guide rail.

13. The apparatus of claim 11, further comprising a pivot member driving means for driving movement of the roller or bar in a direction parallel to the movement of the engagement feature along the guide rail.

14. The apparatus of claim 11, further comprising a clamp comprising a pair of clamping plates downwardly extending from the guide rail, said pair of clamping plates being configured to clamp the target container.

15. The apparatus of claim 1, further comprising at least one drive mechanism configured to move the engagement feature in a substantially vertical direction relative to the pivot member and in a substantially horizontal direction along the guide rail.

16. The apparatus of claim 15, wherein the at least one drive mechanism is configured to move the engagement feature in the vertical direction relative to the guide rail.

17. The apparatus of claim 15, wherein the at least one drive mechanism comprises a linear actuator.

18. A robotized de-palletiser for unloading or loading one or more containers of a plurality of containers stacked up in multiple layers on a pallet, comprising a gantry comprising an apparatus as defined in claim 1, for moving the apparatus axially in multiple X and Y orthogonal directions.

19. A robotized de-palletiser for unloading or loading one or more containers of a plurality of containers stacked up in multiple layers on a pallet, comprising a robot comprising a robot arm, wherein an end effector is coupled to the robot arm for controlling the movement of the end effector to unload or load one or more containers of a plurality of containers stacked up in multiple layers on a pallet, said end effector comprising an apparatus as defined in claim 1.

20. The robotized de-palletiser of claim 19, wherein the robot comprises a selective compliance assembly robot arm (SCARA) robot.
